(19) United States
(12) Patent Application Publication
(10) Pub. No.: US 2016/0106056 A1
(43) Pub. Date: Apr. 21, 2016

(54) Method and System for Housing and Protection During Adverse Environmental Conditions

(71) Applicant: Safe-T-Arm, LLC, Rowlett, TX (US)

(72) Inventor: Robert L. PICCIONI, Rowlett, TX (US)

(21) Appl. No.: 14/975,339

(22) Filed: Dec. 18, 2015

Related U.S. Application Data
(63) Continuation of application No. 14/483,446, filed on Sep. 11, 2014.
(60) Provisional application No. 61/877,256, filed on Sep. 12, 2013.

(51) Int. Cl. A01K 1/00; G05B 15/02; A01K 7/02; E04B 1/343; A01K 29/00; A01K 5/02

(52) U.S. Cl. CPC A01K 1/0047; A01K 29/005; A01K 5/02; A01K 7/02; E04B 1/343; G05B 15/02

(57) ABSTRACT

An enclosure pod for housing and protection of an animal comprises a water-proof hardened structural shell defining a chamber; a door providing entry and exit from the chamber; an air supply system configured to provide sufficient life-sustaining air to the chamber; a lighting system configured to provide ambient lighting to the chamber; a food/water/medicine dispenser; a vitals measuring device; a camera including a speaker and microphone; a global positioning system; a communication system including a transceiver and an antenna; a strobe light; a beacon; a waste containment system; and a computer in communication with the door, the air supply system, lighting system, food/water/medicine dispenser, global positioning system, camera, vitals measuring device, and communication system, the computer being configured to automatically control and in response to remote control of the operations of these elements.

### RELATED APPLICATIONS

The present application is a continuation application of U.S. Non-Provisional patent application Ser. No. 14/483,446 filed on Sep. 11, 2014, which claims the benefit of U.S. Provisional Application, Ser. No. 61/877,256, filed on Sep. 12, 2013, both of which are incorporated herein by reference in their entirety.

### FIELD

The invention relates generally to mechanical systems and more particularly, the invention relates an automated, remotely accessible, hardened enclosure pod to protect animal during adverse environmental conditions such as natural disasters.

### BACKGROUND

As weather related threats such as tornados, fires, and floods have threatened humans and animals for millions of years, humans have strived to build shelters that will act as protection against nature's elements. Great advancements have been made in designing structures to keep humans safe in the event of all types of natural disasters. Unfortunately, structures designed to keep animals safe under the same conditions have been limited or non-existent.

### DESCRIPTION OF THE DRAWINGS

The present disclosure describes various embodiments illustrated in the drawing figures in which like reference numerals refer to like parts throughout the various views unless otherwise specified.

FIG. 1 is a diagram depicting the housing and protection system and method according to the teachings of the present disclosure;

FIG. 2 is a cross-sectional diagram depicting more details of the housing and protection system and method according to the teachings of the present disclosure;

FIG. 3 is another diagram depicting the housing and protection system and method according to the teachings of the present disclosure; and

FIG. 4 is another diagram depicting the housing and protection system and method according to the teachings of the present disclosure.

### DETAILED DESCRIPTION

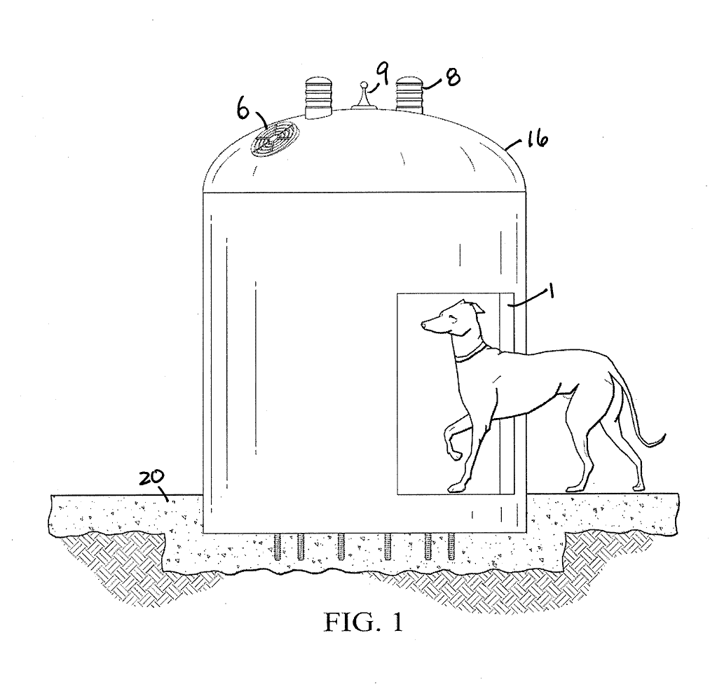

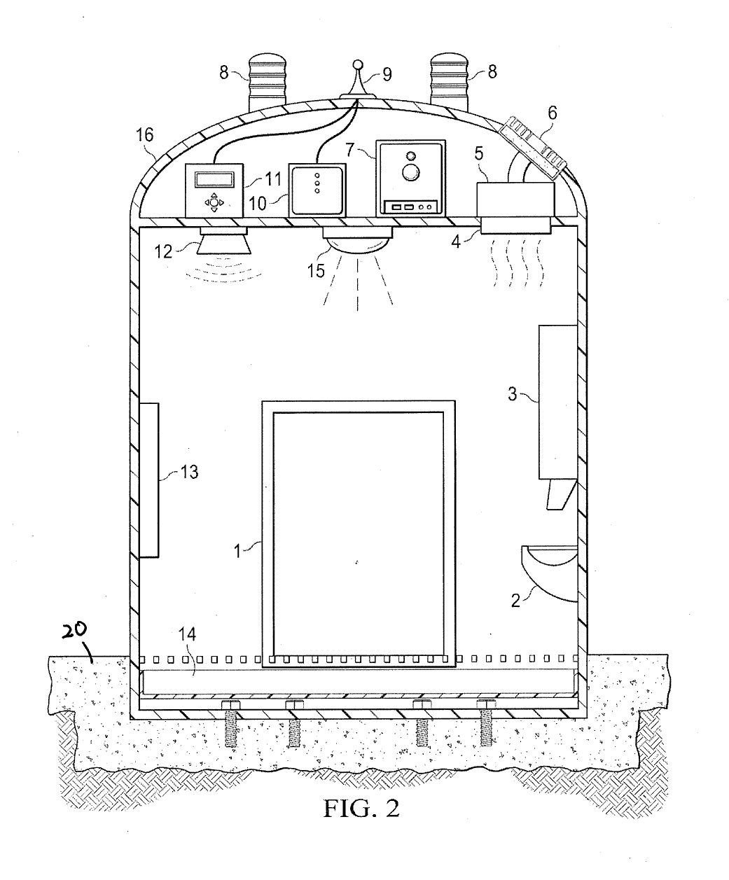

Referring to FIGS. 1-4, a system and method for housing and protection during adverse environmental conditions is shown. A hardened, automated and remotely-controlled animal boarding enclosure pod 16 is designed to withstand all of nature's adverse elements including wind, cold, heat, and flood water. Further contemplated is the use of the enclosure pod for protection from harmful environmental substances such as nuclear radiation, and bio, viral, fungal, or chemical agents, to prevent exposure to these toxic agents. The enclosure pod is equipped with a computer that may automatically initiate pre-programmed functions in response to a potentially hazardous environmental event warning issued by a local, state or federal private or government agency. Although the focus is the protection of pet animals, these pods can be constructed for human use.

The enclosure pod 16 is preferably mounted securely to a firm and solid surface such as a concrete pad 20 and/or structure 26. The enclosure pod 16 preferably includes a hardened outer shell that could withstand high winds, flying objects and pressure from items that might fall upon it or strike it. It would be insulated to withstand high and low temperature variations. Further, the hardened outer shell may include materials that would block the penetration of nuclear radiation. The enclosure pod 16 is preferably constructed of a fire-proof or fire-resistant material. The hardened shell defines an inner chamber that can comfortably house and accommodate one or more animals (e.g., dog, cat, bird, etc.).

The enclosure pod 16 includes an entrance that can be shut and sealed once the animal has entered the enclosure pod. The entrance door 1 can be remotely controlled and operated (opened and shut) via wireless communication and mobile devices such as smartphones, laptop computers, and other devices. Once the door is shut, the enclosure pod 16 provides 360 degrees of sealed protection to an enclosed animal thereby creating a “safety-pod” type enclosure pod to protect from a variety of environmental elements.

The enclosure pod 16 includes a self-contained automated feeding and watering food/water/medicine dispenser 3 and tray 2. The dispenser 3 includes a sensor that detects whether the food tray and/or the water tray need to be replenished, and a computer controller 7 that is configured to dispense pre-portioned amount of food and water as necessary. The food and water dispenser may alternatively operate based on a pre-programmed schedule, and further subject to remote-control by the user. The automated system is powered by a power supply such as one or more batteries 24. The enclosure pod 16 includes a purified air supply system 6 that supplies fresh and filtered air to a heating/cooling system 4 and 5. The air may be supplied from outside of the pod or the pod may be equipped with a certain quantity of air supply (e.g., air tanks). The computer controller 7 and a thermostat are programmed to automatically sense the interior temperature and air quality so that the interior environment of the enclosure pod 16 is regulated to ensure comfort of the occupant. The enclosure pod 16 may also include a variety of sensors that may sense the outside environmental conditions for communications to a remote user. For example, the sensors may detect that the pod is underwater, experiencing high temperatures (possibly indicating fire hazard), or that certain harmful agents, such as carbon dioxide, carbon monoxide, and other poisonous substances, are present. The computer controller 7 is programmed with decisions and logic to consider these factors to maintain the safety of the occupant. The computer controller 7 is coupled to a user interface that enables input of commands and instructions and display of status and other data. For example, the pod may be raised in case of flood, ventilation or oxygen stores may be activated or increased in the presence of certain hazardous gases, fire retardant chemicals may be released in case of fire, etc. Further, automatic notification of the owner, private security firms, or government emergency response agencies may be transmitted when appropriate.

The enclosure pod 16 also includes a GPS beacon 11 or another type of electronic location positioning technology capable of emitting and receiving signals so that the presence and location of the enclosure pod can be quickly determined to effect a rescue. The enclosure pod 16 may also include at least one light source 15 as well as a display monitor and camera device 13 (including speakers and a microphone) to allow for two-way image and audio communication between the animal and a remotely-located user via the Internet or other communication networks. The lighting system 15 can be regulated (brightened and dimmed) by the computer controller 7 to simulate day and night cycles. This lighting system is designed to regulate the animal's internal biological clock to allow the animals eating, sleeping and other habits to not be adversely affected. The enclosure pod 16 may also include a smart collar or another device to measure vital signs (pulse, temperature, etc.) of the animal and communicate this information to the remote user. The communication system may include an antenna 9 and a modem or transceivers 10 to enable the sending and receiving of data.

The enclosure pod 16 would also be capable of emitting a bright light such as a strobe light 8, audible noise (siren), or specialized scent to allow the enclosure pod 16 to be located by third parties or other animals. The enclosure pod 16 preferably include a waste containment system 14 designed to allow waste materials and debris such as feces and urine to pass through a structure such as a grate disposed at the bottom of the enclosure pod to a holding chamber that collect and store the waste. The waste containment system 14 may further include mechanism to discharge the waste from the pod when conditions permit.

The enclosure pod 16 preferably includes a play element or toy to allow the dog or another animal to remain occupied and alert. The enclosure pod 16 may also have the capability of playing pre-programmed messages and/or images stored in a memory accessible by the computer controller 7 on a predetermined time schedule or remotely activated basis.

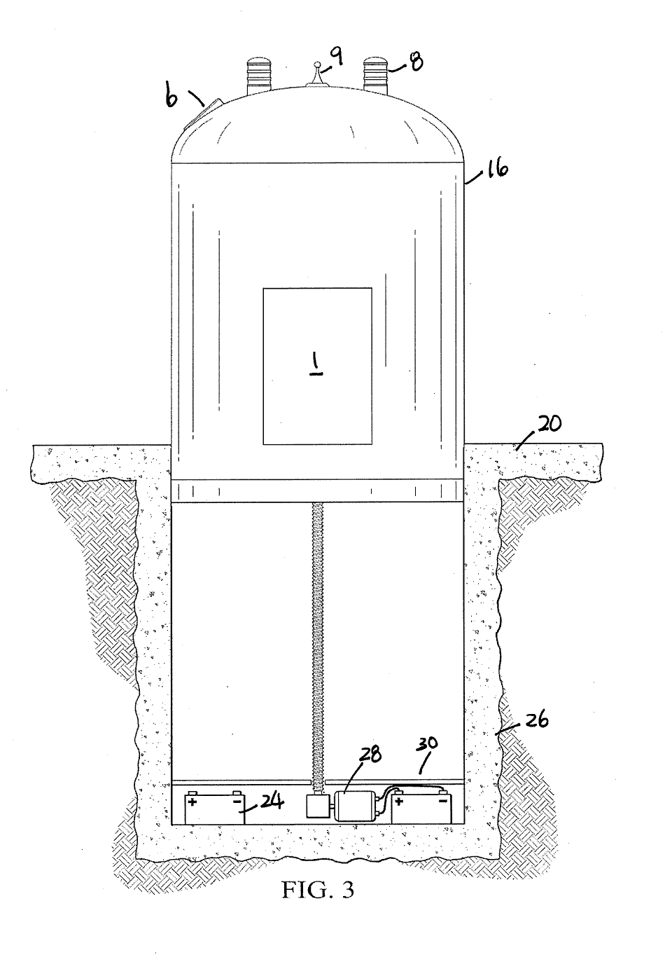

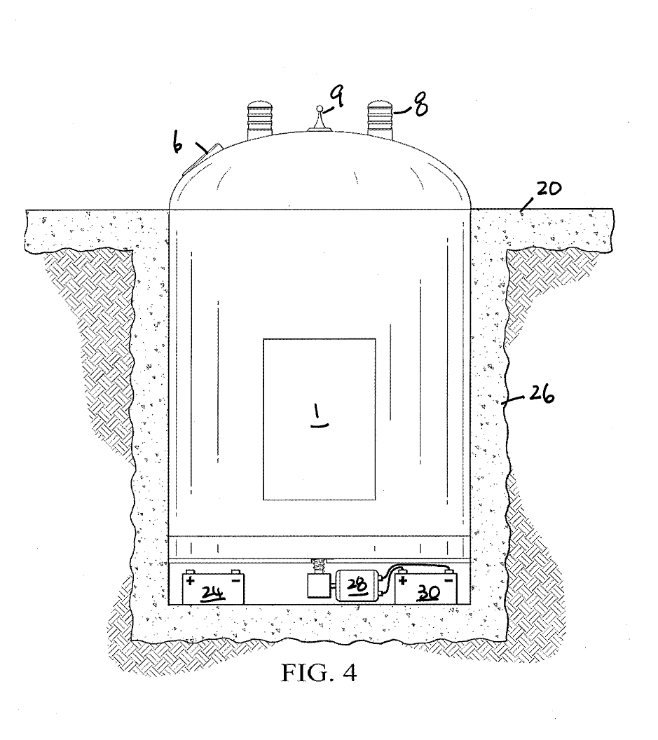

FIGS. 3 and 4 show another embodiment of the enclosure pod 16 that can be raised and lowered into a hardened and secure structure 26 formed in the ground. The raised position permits access to the door of the enclosure pod, and the lowered position permits further protection of the pod by the surrounding structure and ground. The lowered position is more optimal for protection against a tornado, for example. The elevation mechanism include a motor 28 or another mechanism powered by one or more batteries 28. The elevation mechanism may include pneumatic, hydraulic, and other elements. The motor 28 is preferably in communication with the computer controller 7 to enable remote control of its operations, preferably via mobile devices such as a smartphone. The elevation mechanism may also be activated on-site by one or more user interfaces coupled to the computer controller.

It should be recognized that the computer controller 7 described herein may control all or select functionalities associated with the enclosure pod described herein or multiple computer controllers may be employed to control separate functions. It should also be recognized that select or all functions of the enclosure pod described herein can be activated on-site via the user interface, be pre-programmed according to some pre-programmed logic in response to a schedule or a detected condition, or be controlled remotely via the telecommunication network/Internet by a user.

The features of the present invention which are believed to be novel are set forth below with particularity in the appended claims. However, modifications, variations, and changes to the exemplary embodiments described above will be apparent to those skilled in the art, and the novel system and method described herein thus encompasses such modifications, variations, and changes and are not limited to the specific embodiments described herein.

What is claimed is:

1. An enclosure pod for housing and protection of an animal comprising:
a water-proof hardened structural shell defining a chamber;
a door providing entry and exit from the chamber;
an elevation mechanism configured to raise and lower the enclosure pod; and
a computer in communication with the door and the elevation mechanism, the computer being configured to automatically control and operate in response to remote control of the operations of these elements.

2. The enclosure pod of claim 1, further comprising an air supply system configured to provide sufficient life-sustaining air to the chamber and in communication with the computer, the computer being configured to automatically control and operate in response to remote control of the operations of this element.

3. The enclosure pod of claim 1, further comprising a lighting system configured to provide regulated ambient lighting to the chamber and in communication with the computer, the computer being configured to automatically control and operate in response to remote control of the operations of this element.

4. The enclosure pod of claim 1, further comprising a food and water dispenser configured to dispense food and water according to a pre-programmed schedule.

5. The enclosure pod of claim 1, further comprising a food and water dispenser configured to dispense food and water and in communication with the computer, the computer being configured to automatically control, and operate in response to remote control of the operations of these elements.

6. The enclosure pod of claim 1, further comprising an image capture device, a speaker and a microphone and in communication with the computer, the computer being configured to automatically control, and operate in response to remote control of the operations of these elements.

7. The enclosure pod of claim 1, further comprising a transceiver and an antenna configured with a global computer and telecommunication network and in communication with the computer, the computer being configured to automatically control, and operate in response to remote control of the operations of these elements.

8. The enclosure pod of claim 1, further comprising a memory storing pre-recorded images and audio messages that may be played back according to at least one of a predetermined schedule and remotely activated.

9. The enclosure pod of claim 1, further comprising a strobe light.

10. The enclosure pod of claim 1, further comprising a beacon.

11. The enclosure pod of claim 1, further comprising a vital signs measuring device.

12. The enclosure pod of claim 1, wherein the food and water dispenser further comprises a sensor operable to detect absence of food or water, and the dispenser is configured to dispense food or water in response a detected absence of food or water.

13. The enclosure pod of claim 1, further comprising a medicine dispenser.

14. The enclosure pod of claim 1, further comprising a play element. The enclosure pod of claim 1, further comprising a lighting system configured to provide regulated ambient lighting to the chamber according to a pre-programmed schedule.

16. The enclosure pod of claim 1, further comprising at least one sensor configured to detect a potentially hazardous environmental agent.

17. The enclosure pod of claim 16, wherein the computer automatically initiates pre-programmed functions in response to the potentially hazardous environmental agent detected by the sensor.

18. The enclosure pod of claim 16, wherein the computer automatically initiates pre-programmed functions in response to a potentially hazardous environmental event warning issued by a local, state or federal private or government agency.

19. A method for housing and protection of an animal comprising:
providing a water-proof hardened structural shell defining a chamber;
providing a door providing entry and exit from the chamber;
providing an elevation mechanism configured to raise and lower the enclosure pod; and
providing a computer in communication with the door and the elevation mechanism, the computer being configured to automatically control and operate in response to remote control of the operations of these elements.

20. The method of claim 19, further comprising providing a memory storing pre-recorded images and audio messages that may be played back according to at least one of a predetermined schedule and remotely activated.

21. The method of claim 19, further comprising providing a food and water dispenser configured to provide food and water in response to remote control.

22. The method of claim 19, further comprising providing a medicine dispenser configured to dispense medicine to the animal according to a pre-programmed schedule.

23. The method of claim 19, further comprising providing a play element.

24. The method of claim 19, further comprising providing a lighting system configured to provide regulated ambient lighting to the chamber according to a pre-programmed schedule.

25. The method of claim 19, wherein providing the computer comprises providing a computer that automatically initiates pre-programmed functions in response to a potentially hazardous environmental event warming issued by one of a local, state and federal agency.
